(19) United States
(12) Patent Application Publication
(10) Pub. No.: US 2022/0033121 A1
(43) Pub. Date: Feb. 3, 2022

(54) PIPETTE TIP SEPARATING SYSTEM

(71) Applicant: Hektros S.r.l., Bolzano (IT)

(72) Inventor: Daniel HEKL, Innsbruck (AT)

(21) Appl. No.: 17/502,801

(22) Filed: Oct. 15, 2021

Related U.S. Application Data
(63) Continuation of application No. PCT/EP2020/060712, filed on Apr. 16, 2020.

(30) Foreign Application Priority Data
Apr. 18, 2019 (AT) A 50360/2019

(51) Int. Cl. B65B 35/06; B65B 23/22; B65B 35/56

(52) U.S. Cl. CPC B65B 35/06; B65B 35/56; B65B 23/22

(57) ABSTRACT

A separating apparatus includes a feed device for feeding pipette tips, a dispensing device for dispensing pipette tips, a separating device arranged between the feed device and the dispensing device and having a transport shaft rotatably mounted about a longitudinal axis, and a retaining element spaced apart from the transport shaft for retaining the pipette tips. The transport shaft has a thread for moving the pipette tips in an intermediate space between the transport shaft and the retaining element. The transport shaft has a transfer region for transferring the pipette tips from the feed device. The thread has a first thread pitch in the transfer region, and the transport shaft has an acceleration region after the transfer region. The thread has a second thread pitch in the acceleration region which is greater than the first thread pitch.

### BACKGROUND OF THE INVENTION

The invention relates to a separating apparatus for pipette tips, each having a longitudinal axis, comprising a feed device for feeding pipette tips, a dispensing device for dispensing pipette tips, a separating device arranged between the feed device and the dispensing device and having a transport shaft which is mounted rotatable about a longitudinal axis and a holding element, arranged spaced apart from the transport shaft, for holding the pipette tips, wherein the transport shaft is provided, at least in areas, with a thread, by means of which the pipette tips can be moved in an intermediate space between the transport shaft and the holding element along the longitudinal axis of the transport shaft, wherein the longitudinal axes of the pipette tips are arranged substantially perpendicular to the longitudinal axis of the transport shaft during the movement, and wherein the transport shaft has a transfer area for transferring the pipette tips from the feed device, wherein the thread has a first thread pitch in the transfer area.

Pipette tips, as a disposable attachment of pipettors, are by far the most frequently used tool in biomedical research, in pharmacology and in routine analytics. A major research laboratory requires on average up to 5,000 pipette tips per day, wherein in screening laboratories with robot pipetting units a great many more pipette tips are used. The pipette tips are usually supplied by the manufacturers as convenient loose products, especially as pipette tips pre-sorted into pipette tip boxes by the manufacturer are a great deal more expensive. In order to use the pipette tips, for example for transferring fluids or for the precise metering of samples, the pipette tips supplied as loose products are individually loaded into a pipette tip box (pipette racks) by hand. Given the large number of pipette tips required, the manual loading ties up sometimes highly qualified laboratory personnel for hours, wherein the loading represents a tedious and tiring activity which, in the long-run, is ergonomically damaging to health. An automated provision of the pipette tips in pipette tip boxes is therefore of great importance, wherein the geometry and the position of the center of gravity of pipette tips have proved to be unfavorable for sorting them automatically.

Alternatively, pipette tips are also sold stacked in pre-filled plastic or cardboard grids, wherein usually 10 grids are composed of 96 pipette tips each. However, hand loading of the pipette tip boxes is still necessary here, although it can be carried out more easily than in the case of loose products due to the pre-filled grids. Nevertheless, the pre-filled grids are still 10 to 30 times more expensive than loose products loaded into bags. A further disadvantage is that a large quantity of rubbish accumulates, especially as spacers for the pipette tips are always also arranged in the grids.

One difficulty which arises for an automated singling (separation), receipt and orientation of pipette tips with an elongate extent along a longitudinal axis is the unfavorable geometry and center-of-gravity distribution thereof. As a rule, the center of gravity lies namely in the area of the often cylindrical collar. The collar is used for receiving and holding the pipette tip during the pipetting and is arranged at the end facing away from the tapering tip, where liquids are taken up. The collar often has a broader diameter, with the result that the center of gravity often lies far outside the geometric center of the pipette tip. In addition, in the case of loose products the pipette tips often slot into each other due to their hollow conical shape.

At the premises of manufacturers which also offer already pre-sorted and loaded pipette tip boxes, the singling, spatial orientation, and controlled loading of the pipette tips is effected in a multi-stage process in extremely expensive and large industrial plants, which are to some extent operated pneumatically and using industrial robots, which is associated with a correspondingly high level of noise pollution. Naturally, such plants cannot be used in research laboratories.

U.S. Pat. No. 5,426,911 relates to a device for orienting and for transporting pipette tips along the longitudinal direction of two rotatably mounted cylinders oriented in parallel. A separation of the pipette tips does not take place. Rather, they must be fed to this device already singled.

EP 1 832 880 relates to a separation apparatus for pipette tips, wherein loose products in the form of pipette tips are emptied into a rotatable drum, from where they are subsequently transferred via a chute to a rotatably mounted shaft with a thread, thus a transport spindle. The singling is effected before the transport spindle by means of an elaborate mechanism which comprises shearing push-up plates. The singled pipette tips are mounted between the transport spindle and a countershaft. The pipette tips are moved in the longitudinal direction of the transport spindle by a rotation of the transport spindle. Apart from the complex and thus error-prone design of the part of this device in which the pipette tips are separated from each other, no possibility is provided for making it possible to transport a large number of pipette tips arriving at the transport spindle one immediately after another or even at the same time. A “bottleneck” of pipette tips, and thus faulty functioning, is very likely.

A further separation apparatus for pipette tips is shown in CN 102975890. Here too, a transport spindle with a countershaft is used in order to orient the pipette tips and move them along the longitudinal direction of the transport spindle. According to this specification, the singling is effected in that the pipette tips fall down onto the transport spindle in a random arrangement. Since the pipette tips always spin and end up on their edges when they fall, if they are to be arranged in order in a grid of holes provided by the transport spindle and the countershaft, the source of errors for this device is very large and a permanent separation working in an error-free manner is not guaranteed.

### SUMMARY OF THE INVENTION

The object of the invention is to provide a separating apparatus for pipette tips which eliminates the above disadvantages and makes an automated singling and loading of pipette tips supplied as a loose product possible.

Using the separating apparatus according to the invention, pipette tips in very different formats can be singled, i.e. separated, and a pipette tip box can subsequently be loaded with them. In particular, the separating apparatus can be used with the most common formats of pipette tips, which are used for the transfer of fluids of from 1 μl to 500 μl.

The separating apparatus according to the invention for pipette tips having a longitudinal axis has a feed device for feeding pipette tips. The pipette tips can be distributed randomly with respect to their arrangement, as is the case with loose products. A separating device, which has a transport shaft which is mounted rotatable about a longitudinal axis and is provided with a thread at least in areas, is arranged between the feed device and a dispensing device, with which the separated pipette tips are dispensed. The transport shaft is thus a transport spindle with which—in a similar manner to an Archimedes' screw—the pipette tips can be moved along the longitudinal axis of the transport shaft, wherein, for the movement, the pipette tips are arranged in an intermediate space between the transport shaft and a holding element. In the process, during the movement, the pipette tips are arranged along the longitudinal axis of the transport shaft by means of the thread such that the longitudinal axes of the pipette tips are oriented substantially perpendicular to the longitudinal axis of the transport shaft. The longitudinal axis of the pipette tip corresponds to the direction of its longitudinal extent.

The pipette tips are held by the transport shaft and the holding element jointly in the intermediate space between the transport shaft and the holding element. In the case of properly caught pipette tips, during the movement along the longitudinal axis of the transport shaft, the longitudinal axes of the pipette tips are arranged perpendicular to the longitudinal axis of the transport shaft and thus to the direction of movement.

The pipette tips can be held in a friction- and positive-locking manner between the holding element and the transport shaft, in particular, when the pipette tips are arranged in the thread. For this purpose, the thread can be formed as a groove, in which the pipette tips are arranged during the movement along the longitudinal direction of the transport shaft.

The groove can be formed with a semi-circular or also partially elliptical or oval cross section. However, other cross-sectional shapes are also possible for the groove, such as for example triangular or trapezoidal shapes. Such groove cross sections result, in particular, when the thread has been milled into the transport shaft using a tool for a sharp V thread or a trapezoidal thread.

In one embodiment, the holding element is formed as a preferably rotatably mounted holding shaft with a longitudinal axis arranged substantially parallel to the longitudinal axis of the transport shaft. However, a flat holding element is also conceivable, for example a holding plate. The holding shaft can have a smooth surface or likewise be provided with a thread at least in areas. The spacing between the transport shaft and the holding element can be adjusted in one embodiment of the invention. Since the pipette tips are held in the intermediate space between the holding element and the transport shaft, by adjusting the spacing a wide variety of types of pipette tips can be held between the holding shaft and the transport shaft and thus ultimately separated, i.e. singled.

The spacing between holding element and transport shaft is defined as the minimum spacing between the thread (at its deepest point) and the holding element, which results in a direction perpendicular to the longitudinal axis of the transport shaft. Alternatively, however, the spacing can also be defined by the minimum spacing between the thread flank (at its highest point) and the holding element, which results in a direction perpendicular to the longitudinal axis of the transport shaft.

The transport shaft is provided with a thread at least in areas, preferably along its entire longitudinal extent, wherein a transfer area is provided in which the pipette tips are transferred from the feed device. In the transfer area, the thread of the transport shaft has a first thread pitch. Because the transport shaft has an acceleration area, arranged after the transfer area seen in the direction of movement of the pipette tips in the longitudinal direction of the transport shaft, thus in the axial direction, in which the thread has a second thread pitch which is greater than the first thread pitch in the transfer area, the pipette tips can be taken away effectively and quickly from the area in which they are transferred from the feed device.

The pipette tips are moved in the direction of the longitudinal axis of the transport shaft by means of the thread. Because of the smaller thread pitch compared with the thread pitch in the acceleration area, in the transfer area a relatively large number of pipette tips can be transferred from the feed device at the same time or one immediately after another precisely because a relatively large number of indentations, which are formed by the thread, are arranged along the longitudinal extent in the transfer area. However, in the case of a rotation of the transport shaft, the smaller thread pitch is associated with a smaller forward movement in the longitudinal direction of the transport shaft. Since the thread pitch has a larger value in the acceleration area, the forward movement for the pipette tips is greater in the acceleration area. As soon as a pipette tip is thus caught by the thread in the transfer area and is moved into the acceleration area by rotating the transport shaft, a quicker movement can be performed without running the risk of losing the hold of the pipette tips between the transport shaft and the holding element. The transition of the thread pitch from the first value to the second value can take place continuously or also abruptly.

In the case of pipette tips supplied as loose products, it can occur time and time again that several pipettes slot into each other. It is not possible to separate these pipette tips during the transfer from the feed device in the transfer area. In an embodiment of the invention, a control device is therefore provided with which pipette tips that are not separated can be detected. Pipette tips slotted into each have a longer overall length than singled pipette tips. Due to the conical tip, they are held substantially in the same area between holding element and the transport shaft. However, in the area opposite the tip pipette tips slotted into each other protrude further out of the area between holding element and transport shaft than singled pipette tips.

In an embodiment, the control device is formed as a stop element. Correctly separated pipette tips only protrude out of the area between holding element and transport shaft to the extent that they can pass underneath the stop element, whereas pipette tips that are slotted into each other strike the stop element. Since pipette tips slotted into each other, like singled pipette tips, are moved in their longitudinal direction due to the rotation of the transport shaft, striking the stop element can bring about a rotation of the pipette tips slotted into each other, which makes it possible to remove the pipette tips slotted into each other.

The rotated pipette tips that are slotted into each other can fall into a collecting area underneath the transport shaft, from where they are returned to the feed device via a return device. However, it is also conceivable that the pipette tips collected in the collecting area are returned manually.

In an embodiment of the invention, the control device is arranged in the acceleration area. This makes sense, in particular, when the control device is formed as a stop element. Due to the greater pitch of the thread in the acceleration area, in the longitudinal direction of the transport shaft there is more space for pipette tips slotted into each other to be able to fall through the stop element into the collecting area during a rotation.

In order to facilitate this further, in an embodiment of the invention the areas between the thread in the acceleration area of the transport shaft are formed as passing areas for the pipette tips. For example, the areas between the thread in the acceleration area can be formed as free spaces, with the result that the passing areas for pipette tips form between the free spaces and the holding element. These free spaces can also be formed in the shape of a second thread, which is arranged between the thread flanks in the acceleration area. Pipette tips which are not held sufficiently by the thread and the holding element can fall downwards through the passing areas into a collecting area, for instance after they are detected by the control device.

In an embodiment of the invention, the transport shaft has a dispensing area arranged after the acceleration area, wherein this again relates to the direction of movement of the pipette tips in the longitudinal direction of the transport shaft. In this sense, in the axial direction the acceleration area is arranged after the transfer area and the dispensing area is arranged after the acceleration area. In the dispensing area, the thread can have a third thread pitch, which is smaller than the second thread pitch in the acceleration area. The transition from the second to the third thread pitch can take place continuously or abruptly. The third thread pitch can correspond to the first thread pitch, but it can also be smaller or greater than the first thread pitch. Due to the smaller thread pitch compared with the acceleration area, in the dispensing area the pipette tips are moved more slowly in the direction of the longitudinal axis of the transport shaft.

In the dispensing area, the pipette tips are transferred to the dispensing device, where they are dispensed and/or transferred to a or into a pipette tip box. It can be provided that an empty run, in which the pipette tips are no longer moved in the direction of the longitudinal axis of the transport shaft but are held stationary, is arranged at the end of the dispensing area facing away from the acceleration area. This makes a particularly simple dispensing of the pipette tips possible. For example, here the dispensing device can be formed as a push rod that is stationary in relation to the longitudinal axis of the transport shaft. Alternatively, the dispensing area can have a transfer area, into which the pipette tips to be transferred into the pipette tip box are transferred and temporarily collected there. One example of such a transfer area is the dispensing shaft described in this application.

In the case of a third thread pitch in the dispensing area which is smaller than the second thread pitch in the acceleration area, in the dispensing area of the transport shaft the pipette tips are guided more slowly in the direction of the longitudinal axis of the transport shaft. As a result of which, a more precise and more secure dispensing of the pipette tips is made possible, thereby minimizing the danger that the pipette tips will be moved, for instance, beyond the empty run or beyond the transfer area and thus dispensing cannot be effected.

The speed with which the pipette tips are moved along the longitudinal direction by the thread depends, in the case of a predefined thread pitch, only on the rotational frequency of the transport shaft. As a result, within the framework of a control procedure, for example after detection of a pipette tip by a detection device in the dispensing area, a slower movement of the pipette tips can be achieved by temporarily reducing the rotation speed.

In an embodiment of the invention, the spacing between the transport shaft and the holding element is smaller in the dispensing area than in the acceleration area. This can be achieved by the thread flanks having a greater height in this area, i.e. the thread is formed less deep, or the shaft itself, on which the thread is arranged, having a larger diameter. Alternatively, the spacing can also be determined by a corresponding design of the holding element. The reduction in spacing can take place continuously or abruptly, for instance if the height of the thread flanks or the diameter of the shaft, on which the thread is arranged, increases continuously. In this case, an enveloping surface around the dispensing area can adopt a conical shape. The reduction in spacing increases the frictional locking with which the pipette tips are held between the transport shaft and the holding element, as a result of which a stable hold becomes possible when the singled pipette tips are dispensed by the dispensing device, which has a push rod, for example.

Properly caught pipette tips are held in a friction-locking and a positive-locking manner by the holding element and the transport shaft in the intermediate space between holding element and transport shaft. The positive locking relates to a direction arranged perpendicular to the longitudinal axis of the transport shaft, thus to the direction of the longitudinal axis of the properly caught pipette tips. As a consequence of the conical formation of the pipette tips and of the pipette collar arranged in the area as a rule, the predefined spacing between holding element and transport shaft prevents a further movement of the pipette tips in this direction, with the result that there is a positive-locking connection. At the same time, the pipette tips are clamped between holding element and transport shaft, as a result of which a friction-locking connection also forms. The connection is even preserved, at least in the case of a properly positioned pipette tip, during the movement along the longitudinal direction of the transport shaft. The holding function of the holding element thus relates to a direction perpendicular to the longitudinal direction of the transport shaft.

In an embodiment of the invention, the thread of the transport shaft is formed, at least in areas, preferably in its entirety, as a groove, in which the pipette tips can be arranged for the movement in the longitudinal direction of the transport shaft. Depending on the dimension of the groove, a better hold of the pipette tips is thereby possible since a positive locking can also be realized in the longitudinal direction of the transport shaft. The thread flanks of the transport shaft can, at least in areas, have an area that is flattened in a side view. In particular, the thread of the transport shaft can be created by milling into a cylindrical shaft with a smooth surface.

The thread flanks then correspond to the wall of the thread, wherein the areas between the thread are not machined and are thus formed flat in a side view. A different design of the areas between the thread is also possible, however, at least in areas, for example as described above.

In particular, in the case of the formation as a groove, it can be provided that the depth of the thread remains constant. As already described, however, the thread is formed with varying depths. For example, the thread, in particular in the shape of a groove, can be formed deeper in the dispensing area, in order to achieve a better hold and thus also a more secure and error-free dispensing of the pipette tip. In contrast, the thread can be formed less deep in the acceleration area, in order to more easily separate out pipette tips that have not been correctly singled.

In an embodiment, the dispensing device has at least one push rod, which has a receiving element mounted movable in a direction perpendicular to the longitudinal direction of the transport shaft. The push rod can thus receive pipette tips arranged in the dispensing area and subsequently position them in a pipette tip box. For this, the push rod or the entire dispensing device with the received pipette tip can be moved. Alternatively, the pipette tip box is moved relative to the push rod.

The dispensing device can also have several push rods, which remove several pipette tips from the dispensing area at the same time or in quick succession and put them in a pipette tip box. For receiving the pipette tips, the push rod can have, for example, a cylindrical or conical part that is movable perpendicular to the longitudinal direction of the transport shaft during the movement, can be introduced into the upper opening (opposite the tip) and makes a friction-locking connection with the pipette tip. As a result, the pipette tip remains hanging on the push rod when the latter is moved in the direction of the pipette tip box.

In a further embodiment of the invention, the dispensing device has a dispensing shaft which is mounted rotatable about a longitudinal axis and is provided, at least in areas, preferably in its entirety, with a thread. As in the case of the transport shaft, the thread can be formed as a groove. A holding means arranged spaced apart from the dispensing shaft is provided for holding the pipette tips. By means of the thread, the pipette tips can be moved along the longitudinal axis of the dispensing shaft in an intermediate space between the dispensing shaft and the holding means. The holding means, like the holding element in the area of the transport shaft, serves to hold the pipette tip in a friction-locking and positive-locking manner.

In an embodiment, the dispensing shaft and the transport shaft can be mounted rotatable independently of each other.

Preferably, the longitudinal axis of the dispensing shaft and the longitudinal axis of the transport shaft are parallel or coincide. In particular, the dispensing shaft can transition into the transport shaft with a very small spacing.

In an embodiment, a detection device is provided for detecting a pipette tip moved into the dispensing area of the transport shaft. In the case of the detection of a pipette tip, a control command to rotate the dispensing shaft can be transmitted by a control device.

In a further embodiment, the dispensing shaft and the transport shaft are formed in one piece. In this case, an independent rotation of the dispensing shaft is not possible.

In an embodiment, the holding element and the holding means are formed in one piece, in particular, when the longitudinal axis of the dispensing shaft and the longitudinal axis of the transport shaft coincide. In this case, the holding element is lengthened in the direction of the dispensing shaft. This is possible, in particular, in the case of a holding shaft.

For loading the pipette tips into the pipette tip boxes, pipette tips, which are transferred together into a pipette tip box, are arranged continuously on the dispensing shaft. This can be realized in particular with a rotation of the dispensing shaft that is independent of the transport shaft.

In an embodiment of the invention, the pitch of the thread of the dispensing shaft is chosen such that it corresponds to the spacing of the pipette tips arranged in the pipette tip box, thus to the grid of the receiving holes in the pipette tip box. Since, in an embodiment of the invention, the pipette tip box is positioned underneath the dispensing shaft during the dispensing of the pipette tips from the dispensing area, the positioning of the pipette tips in the pipette tip box can be effected simply in that the connection between the pipette tips and the holding means is broken and the pipette tips fall or are guided vertically downwards into the pipette tip box.

The center point spacing of these grid holes for the most widely used types of pipette tips is often approximately 9 mm. In an embodiment of the invention, the pitch of the thread of the dispensing shaft is therefore chosen such that the spacing of the indentations on the dispensing shaft formed by the thread is between 6 and 12 mm, preferably between 8 and 10 mm and quite preferably approximately 9 mm.

The first turn of the thread on the dispensing shaft after the transport shaft, thus the first indentation facing the holding means, does not necessarily represent the first position at which pipette tips can be dispensed, for example, vertically downwards into the pipette tip box. It can, for example, be provided that only the third or fourth turn of the thread on the dispensing shaft, thus the third or fourth indentation facing the holding means, represents the first position at which pipette tips are dispensed, for example, vertically downwards into the pipette tip box. In these cases, the number of turns of the thread on the dispensing shaft, i.e. the number of indentations facing the holding means, is at least one times, mostly however at least three or four times, larger than the maximum number of pipette tips to be dispensed at the same time.

Since pipette tip boxes often have 6×8, 8×12 or 16×24 grid holes for receiving pipette tips, it makes sense for the thread along the dispensing shaft to form at least three or four more indentations than 6, 8, 12, 16 or 24 in order to make it possible to load a whole row or a whole column of a pipette tip box at the same time. However, it is also possible to achieve any desired pattern of loading the grid holes in the pipette tip box, because individual indentations are left free according to a predetermined pattern and no pipette tips are arranged there for dispensing. In particular, individual pipette tips can thereby be positioned at a desired, predetermined position within a row or column in the pipette tip box. This makes sense above all when already partially loaded pipette tip boxes are fully loaded using the separating and loading device according to the invention, thus the missing pipette tips are to be added.

Moreover, the position of the indentations on the dispensing shaft can be adjusted as desired in the longitudinal direction relative to the holding means for positioning over the pipette tip box by partial rotations of the dispensing shaft about its longitudinal axis. As a result, it is thus possible, for example, to load a row having 24 grid holes and a hole spacing of 4.5 mm using a dispensing shaft adapted per se for loading a row having 12 grid holes and a hole spacing of 9 mm, by first of all positioning 12 pipette tips in every second grid hole in the pipette tip box. During the second pass, the pipette tips are then positioned in the 12 grid holes lying in between. For this, the dispensing shaft is rotated by a half revolution (by 180°) about its longitudinal axis, as a result of which the position of the indentations with respect to the holding means is offset by 4.5 mm in the longitudinal direction.

For loading the pipette tip box, push rods as described above can be provided, wherein it is again advantageous if the push rod or rods have a total of 6, 8, 12, 16 or 24 receiving elements. It can also be provided that the spacing between holding means and dispensing shaft is increased as soon as the pipette tip box is arranged underneath the dispensing shaft. As a result, the pipette tips are automatically positioned in the holes of the pipette tip box. However, for this purpose a transfer device, which is arranged, for example, on the holding means, can also be provided.

In a further embodiment of the invention, the holding element has at least one dropping device with which pipette tips which are not properly caught and are arranged outside the thread during the movement along the longitudinal direction of the transport shaft can be removed from the separating apparatus. These are pipette tips that have not been correctly singled or caught, and which cannot be properly sorted into a pipette tip box. Again, using such a dropping device, these pipette tips can be put into a collecting area, from where they are returned to the feed device.

The invention further relates to a separating and loading device for pipette tips with a filling device for pouring in pipette tips to be separated, a separating apparatus—as described above—and a removal device, from which pipette tips that have been separated and sorted into a pipette tip box can be removed.

Because of the design of the separating apparatus, the separating and loading device according to the invention can be formed as a compact table-top unit for everyday laboratory work which makes it possible to load pipette tips of various formats and from a wide variety of manufacturers into pipette tip boxes provided for this purpose in a fully automated manner and according to the daily requirement.

Using the separating and loading device it is possible to transfer the pipette tips, which have been poured into the filling device as loose products and have been successfully and correctly singled by the separating apparatus, into pipette tip boxes having a standardized filling grid. The separating and loading device further has a removal device, from which the pipette tip boxes can be removed. In the simplest case, the removal device is an opening in the separating and loading device. However, the separating and loading device, in particular the removal device, can also have a movable part, for example a turntable, with which the loaded pipette tip boxes are moved to an opening and empty pipette tip boxes are moved to the dispensing device.

In an embodiment, the removal device can have a mechanism, by means of which the pipette tip boxes can be moved sequentially in one or more directions, in order that the pipette tips can be correctly transferred by the dispensing device and inserted into the holes of the pipette tip box. Additionally or alternatively the dispensing device or the entire separating apparatus can also be moved towards the pipette tip box.

In an embodiment, the filling device of the separating and loading device has a preferably rotatably mounted drum. The pipette tips are distributed by rotating the drum, wherein the rotation also makes it possible for pipette tips that are slotted into each other to be released from each other. If the separating and loading device has a return device, by means of which pipette tips not dispensed by the dispensing device can be transferred to the feed device, it can be provided to transfer these pipette tips into the filling device, in particular into the rotatably mounted drum. The collecting area for pipette tips that have not been correctly singled can also be arranged in the drum.

In a further embodiment, the separating and loading device has a storage area for storing empty and/or loaded pipette tip boxes. The stored pipette tip boxes can be moved towards the dispensing device, loaded with pipette tips there and subsequently moved to a removal area, where the loaded pipette tip boxes can be removed.

In a preferred embodiment of the separating and loading device, the longitudinal axis of the transport shaft is mounted horizontally in the operating state of the device. As a result, pipette tips that have not been correctly singled can automatically fall into a collecting area under the action of gravity, from where they are returned into the feed device manually or using a return device.

The separating and loading device can have a corresponding feedback sensor system for automatically detecting the formats of the pipette tips. It can also be provided to input the format of the pipette tips to be separated via a control panel. The separation apparatus can be controlled via a motor, for example a stepper motor, wherein the spacing between the transport shaft and the holding element is automatically adjusted via a regulation device according to the different collar geometries and lengths of the various pipette tips. An automatic calibration can be effected for each separating procedure.

In particular, the separating and loading device according to the invention can operate without pneumatic or compressed-air-controlled components, as a result of which a low-noise operation is possible. In the case of a compact table-top unit, several pipette tip boxes can be loaded per operation cycle and loading with loose products can be effected.

The invention further relates to a method for operating a separating apparatus for pipette tips, in particular as described above, wherein the pipette tips are fed via a feed device to a separating device, which has a transport shaft mounted rotatable about a longitudinal axis and a holding element arranged spaced apart from the transport shaft for holding the pipette tips. The transport shaft further has a thread, at least in areas, by means of which the pipette tips are moved along the longitudinal axis of the transport shaft in the intermediate space between the transport shaft and the holding element. The spacing between the transport shaft and the holding element is chosen such that the pipette tips, in a transfer area of the transport shaft in which the pipette tips are transferred from the feed device, in the area of their center of gravity, are mounted rotatable about an axis arranged perpendicular to the longitudinal axis of the transport shaft. As a result, the pipette tips can be lowered with the tip downwards.

In an embodiment of the method according to the invention, the longitudinal axis of the transport shaft is mounted horizontally and, for moving the pipette tips, is rotated such that the areas of the transport shaft facing the holding element are moved upwards. As a result, the pipette tips can be prevented from becoming wedged.

### BRIEF DESCRIPTION OF THE DRAWINGS

Further advantages and details of the invention are discussed, for various embodiment examples, with reference to the following figures. There are shown in:

FIG. 1 a schematic representation of the functional units of a separating and loading device according to the invention,

FIGS. 2a to c a top view, a cross section and a front view of a schematic representation of a separating device,

FIGS. 3a, 3b a cross-sectional representation and a front view of a schematic representation of a separating device,

FIGS. 4a to c a top view, a cross section and a front view of a schematic representation of a separating device,

FIGS. 5a to c a top view, a cross section and a front view of a schematic representation of a separating device,

FIGS. 6a to c a top view, a cross section and a front view of a schematic representation of a separating device,

FIGS. 7a to c a top view, a cross section and a front view of a schematic representation of a separating device,

FIGS. 8a to c a top view, a cross section and a front view of a schematic representation of a further embodiment of the separating device,

FIGS. 9a to c a top view, a cross section and a front view of a schematic representation of the further embodiment of the separating device,

FIGS. 10a to c a top view, a cross section and a front view of a schematic representation of the further embodiment of the separating device,

FIGS. 11a, 11b a side view and a cross-sectional representation of an embodiment of the transport shaft,

FIGS. 12a, 12b a top view and a cross section of a schematic representation of a separating apparatus,

FIGS. 13a, 13b a top view and a cross section of a schematic representation of a separating apparatus,

FIGS. 14a to d a top view, two cross sections of a schematic representation of a further embodiment of a separating apparatus as well as a side view of the holding element,

FIGS. 15a to d a top view, two cross sections of a schematic representation of this embodiment of a separating apparatus as well as a side view of the holding element,

FIGS. 16a to d a top view, two cross sections of a schematic representation of this embodiment of a separating apparatus as well as a side view of the holding element,

FIGS. 17a to d a top view, two cross sections of a schematic representation of this embodiment of a separating apparatus as well as a side view of the holding element,

FIG. 18 a partially cut open perspective view of a separating and loading device according to the invention, and

FIG. 19 a partially cut open side view of a separating and loading device according to the invention,

FIG. 20 a partially cut open perspective view of a further embodiment of a separating and loading device according to the invention,

FIG. 21 a further partially cut open perspective view of this embodiment of a separating and loading device according to the invention,

FIG. 22 a perspective view of parts of this embodiment of a separating and loading device according to the invention,

FIG. 23 a further partially cut open perspective view of this embodiment of a separating and loading device according to the invention,

FIG. 24 a further partially cut open perspective view of this embodiment of a separating and loading device according to the invention, and

FIG. 25 a perspective detail view of a further embodiment of the separating and loading device.

### DETAILED DESCRIPTION OF THE INVENTION

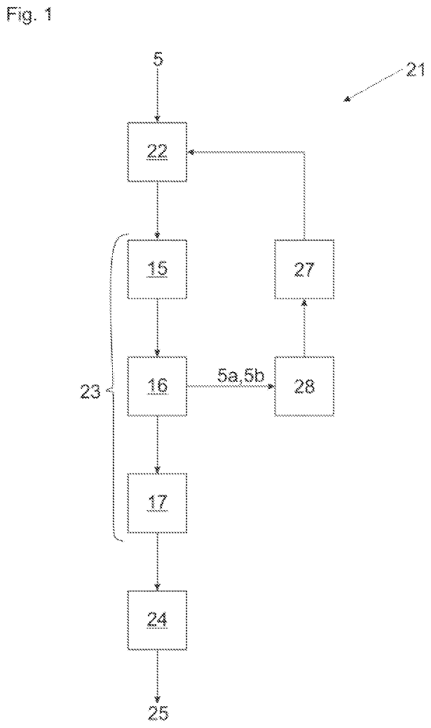

FIG. 1 shows a schematic representation of the functional units of a separating and loading device 21 according to the invention. The pipette tips 5 to be separated are put into a filling device 22 for example in the form of loose products, from there they are transferred into a feed device 15, by which the pipette tips 5 to be separated are fed to a separating device 16, which singles, i.e. separates, the pipette tips 5. In the singled state, the pipette tips 5 are dispensed from the separating apparatus 23 by a dispensing device 17 and positioned in pipette tip boxes 25. The loaded pipette tip boxes 25 can then be removed from a removal device 24. In an embodiment of the invention, pipette tips 5a, 5b that are not separated are collected in a collecting area 28 and returned to the filling device 22 using a return device 27.

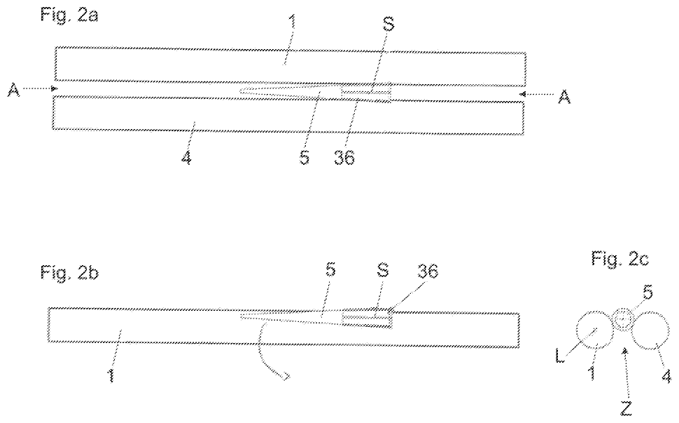

FIG. 2a shows a top view of a schematic representation of a separating device 16. For reasons of clarity, the thread 2 and the thread flank 3 of the transport shaft 1 are not represented in FIGS. 2a to 2c. In this embodiment of the invention, the holding element 4 is a holding shaft, the longitudinal direction of which is arranged parallel to the longitudinal axis L of the transport shaft 1. The spacing d between the transport shaft 1 and the holding element 4 is chosen such that pipette tips 5 which are fed by the feed device 15 in an orientation substantially parallel to the longitudinal axis L of the transport shaft 1 of the separating device 16, in the area of their center of gravity S, which is located in the area of the collar 36 of the pipette tip 5, are mounted rotatable about an axis arranged perpendicular to the longitudinal axis L of the transport shaft 1.

In the front view of FIG. 2c, a fed pipette tip 5 can be seen in the intermediate space Z between the transport shaft 1 and the holding shaft 4. In the operating state of the separating and loading device 21, the longitudinal axis L can be mounted horizontally. In FIG. 2c, the longitudinal direction of the fed pipette tip 5 is then likewise oriented substantially horizontally. The pipette tips 5 to be separated can generally be fed to the separating device 16 by the feed device 15 in a wide variety of orientations, with the result that the pipette tips 5 in principle can land in any conceivable position on the separating device 16. Depending on the embodiment of the feed device 15, the pipette tips 5 are often fed to the separating device 16 rolling, with the result that the pipette tips 5 often come to lie horizontally.

In the cross-sectional representation of FIG. 2b, along the section line A-A according to FIG. 2a, it is shown how the fed pipette tip 5 can rotate about its center of gravity. This rotation makes it possible for the pipette tips 5 to be easily caught by the thread 2 of the transport shaft 1.

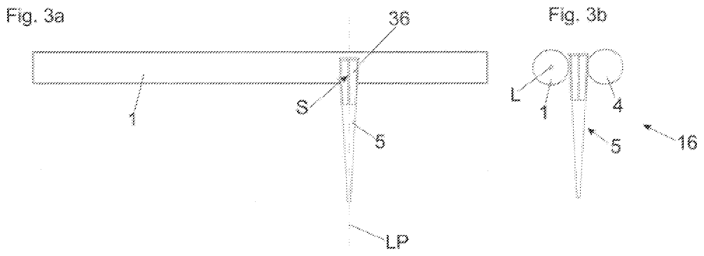

FIG. 3a corresponds to the cross-sectional representation of FIG. 2b, wherein the pipette tip 5 is now rotated by approx. 90° and is located in a convenient position for catching by the thread 2. It can further be seen that the longitudinal axis LP of the pipette tip 5, represented dashed, is arranged perpendicular to the longitudinal axis L of the transport shaft 1. FIG. 3b shows the separating device 16 in a front view and corresponds to FIG. 2c, but with the pipette tip 5 rotated by approx. 90°.

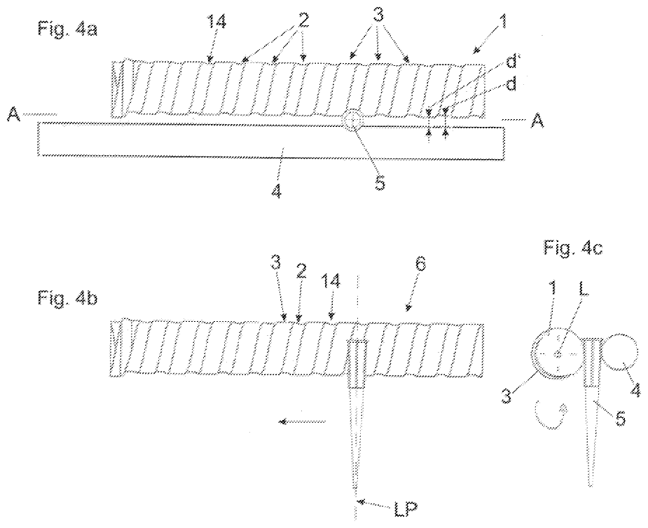

FIG. 4a shows a schematic top view of a separating apparatus 16, wherein in this representation the transfer area 6 of the transport shaft 1 is represented. The holding element 4 is formed as a holding shaft with a smooth surface, as a result of which the movement of the pipette tip 5 by the thread 2 in the sense of an Archimedes' screw in the longitudinal direction of the transport shaft 1 is made easier. The areas between the thread 2 are formed flat in the side view and in the top view, with the result that capturing the pipette tips 5 in the thread 2 formed as a groove 14 is made easier. The thread flanks 3 are thus flattened. In the groove 14, the pipette tip 5 is held not only in a friction-locking manner but also in a positive-locking manner, wherein the positive locking results downwards due to the conical design of the pipette tip 5 and the pipette collar 36. The pipette tip 5 is thus now properly caught and is held during its movement along the longitudinal axis L of the transport shaft 1 by means of the thread 2 such that the longitudinal axis LP is oriented substantially perpendicular to the longitudinal axis L, as can be seen particularly well in FIG. 4b. The pipette tips 5 are held in the thread 2 by the thread flank 3. However, the pipette tips 5 can move when the transport shaft 1 is rotated despite the connection to the holding shaft and the transport shaft 1 in the longitudinal direction of the transport shaft, namely together with the thread 2 which is moved when the transport shaft 1 is rotated about the longitudinal axis L.

In the cross-sectional representation of FIG. 4b, the direction of movement of the pipette tip 5 is symbolized by the straight arrow. During this movement, the longitudinal axis LP of the pipette tip 5, represented dashed, is arranged perpendicular to the longitudinal axis L of the transport shaft 1. The spacing d between the transport shaft 1 and the holding element 4 is given by the minimum spacing between the deepest point of the thread 2 and the surface of the holding element 4 in a direction perpendicular to the longitudinal direction of the transport shaft 1. Alternatively, the spacing d′ can also be defined by the minimum spacing between the highest point of the thread flank 3 and the surface of the holding element 4 in a direction perpendicular to the longitudinal direction of the transport shaft 1. The spacing d (or the spacing d′) is chosen such that it is possible for the pipette tip 5 to be held securely during the movement.

A front view of the separating device 16 is shown in FIG. 4c. The transport shaft 1 is rotated such that the areas of the transport shaft 1 facing the holding element 4 are moved upwards, in this case counter-clockwise. This prevents the pipette tip 5 from becoming wedged.

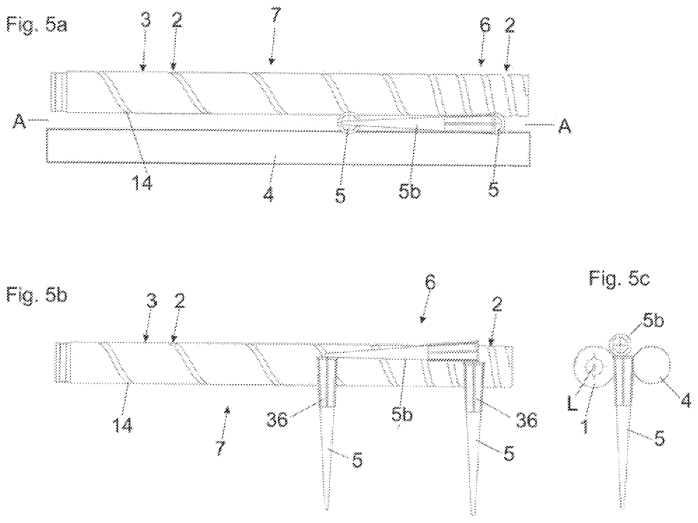

A top view of a schematic representation of a separating device 16 is shown in FIG. 5a, wherein the transport shaft 1 with the transfer area 6 and the acceleration area 7 is represented. It can be seen that two pipette tips 5 are arranged properly in the thread 2 formed as a groove 14. A third pipette tip 5b has not been properly transferred from the feed device 15, but is lying on the collars 36 of the pipette tips 5. This is not an infrequent occurrence in particular when larger quantities of pipette tips 5 have to be singled. However, the separating apparatus 23 according to the invention can remedy these errors by correctly catching, i.e. correctly singling, the pipette tip 5b and hooking it into the thread 2 or feeding it to the separating device 16 again by (passive) return via the collecting area 28 and/or the return device 27.

It can further be seen that the first thread pitch s1 in the transfer area 6 is much smaller than the second thread pitch s2, wherein the increase takes place continuously. Due to the increased thread pitch s2, the pipette tips 5 are accelerated after being securely transferred and moved much more quickly in the longitudinal direction of the transport shaft 1 when the transport shaft 1 is rotated about its longitudinal axis L.

FIG. 5b shows a cross-sectional representation along the section line A-A. FIG. 5c shows a front view of the separation device 16 according to FIGS. 5a and 5b, wherein again the pipette tip 5b lying on the collar 36 of the pipette tip 5 can be seen.

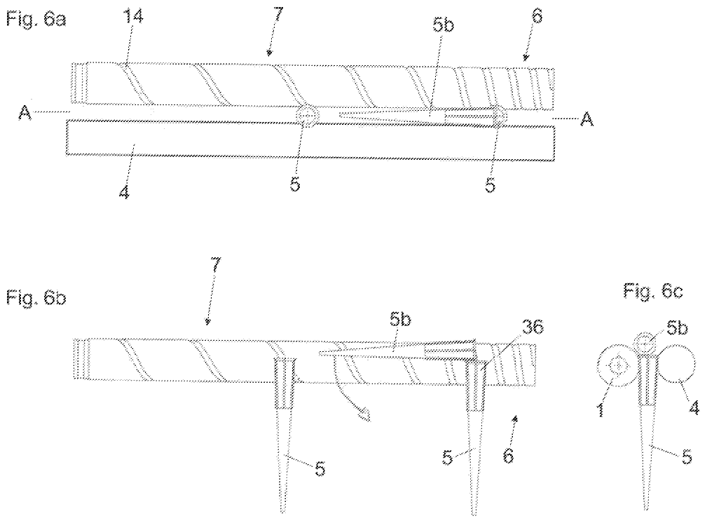

FIGS. 6a to 6c represent the separating device 16 of FIGS. 5a to 5c after a rotation of the transport shaft 1. Whereas in FIGS. 5a to 5c both pipette tips 5 properly caught in the thread 2 are still arranged in the transfer area 6, in FIGS. 6a to 6c the first pipette tip 5 in the direction of movement is already located in the middle of the acceleration area 7. On the other hand, the second pipette tip 5 is still arranged in the transfer area 6 and during the rotation of the transport shaft 1 moves more slowly in the longitudinal direction of the transport shaft 1 than the pipette tip 5 located further to the left. The pipette tip 5b that is not caught properly and, in the situation of FIGS. 5a to 5c, is still lying on the collars 36 of both pipette tips 5 loses the hold, at its left-hand end, by the pipette tip 5 arranged further to the left, which moves away underneath it, and thus rests on only one collar 36. As a result, the pipette tip 5b can rotate about an axis perpendicular to the longitudinal axis L of the transport shaft 1 and be caught by the groove 14 in the transfer area 6. This is only possible because the pipette tip 5 is moved in the longitudinal direction of the transport shaft 1 more quickly in the acceleration area 7 and as a result the spacing between the two pipette tips 5 is increased in the longitudinal direction of the transport shaft 1. The rotation of the pipette tip 5b is shown by the arrow in the cross-sectional representation of FIG. 6b. FIG. 6c shows the separation device 16 of FIGS. 6a and 6b in a front view.

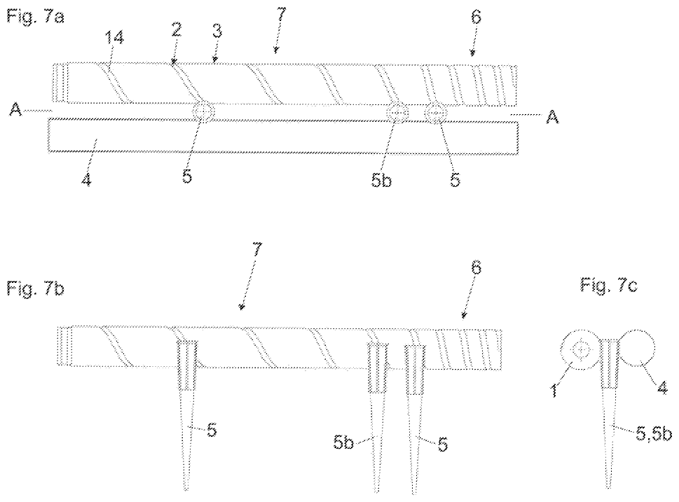

The situation resulting after a further rotation of the transport shaft 1 about its longitudinal axis L is shown in FIGS. 7a to 7c. The pipette tip 5b formerly not properly caught is now properly caught and can subsequently be sorted into a pipette tip box 25. Due to the acceleration of the movement in the acceleration area 7, a larger gap forms between the pipette tips 5, within which the pipette tip 5b that was not properly caught could be rotated.

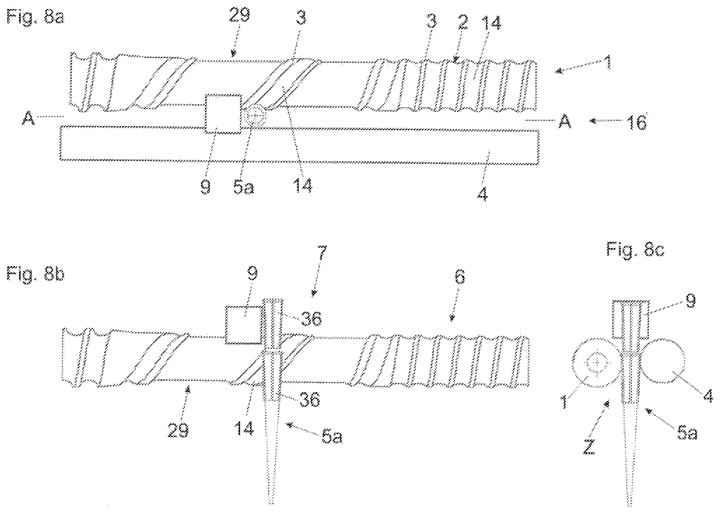

FIG. 8a shows a further embodiment of the separating device 16, wherein a control device 9 formed as a stop element is arranged above the acceleration area 7. The control device 9 acts as a height control. Pipette tips 5a slotted into each other namely protrude further out of the intermediate space Z between holding element 4 and transport shaft 1 and cannot pass under the stop element 9. This is shown particularly well in the cross-sectional representation of FIG. 8b, along the section line A-A according to FIG. 8a, and also in the front view of FIG. 8c.

In this embodiment, in the acceleration area 7, areas between the thread 2 are further formed as free spaces 29, which are characterized in that the transport shaft 1 is cut out deeper in these free spaces 29. The free spaces form a second thread between the thread flanks 3, which is so deep, however, that pipette tips 5 cannot be held between holding element 4 and transport shaft 1. In the case of the free spaces 29 there is thus a passing area for the pipette tips 5a slotted into each other two or more times, which can fall downwards in this area in the intermediate space Z, where they are collected in a collecting area 28.

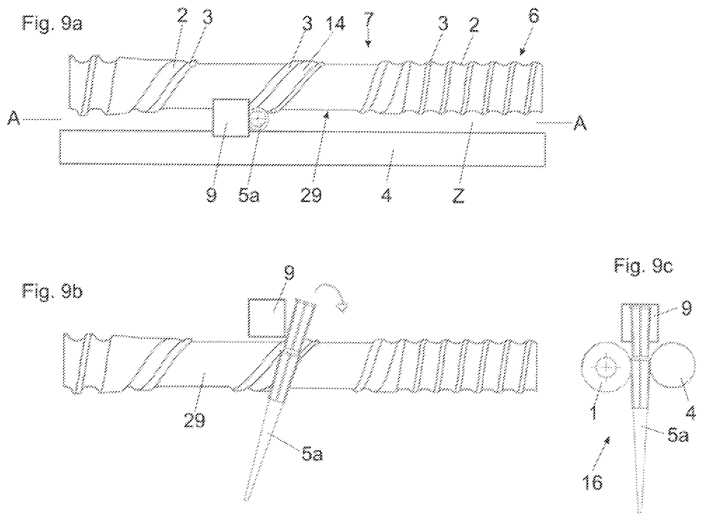

FIGS. 9a to 9c show the separating device 16 shown in FIGS. 8a to 8c a short time later, while the transport shaft has been rotated further about its longitudinal axis L by a certain angle. The pipette tips 5a that are slotted into each other are rotated along the arrow shown in the cross-sectional representation of FIG. 9b by the control device 9 formed as a stop element. In contrast, singled pipette tips 5 can pass underneath the control device 9a. The pipette tips 5a that are slotted into each other are raised out of the thread 2 and fall through in the passing area at the free spaces 29 into the collecting area 28. FIG. 9c again shows a front view.

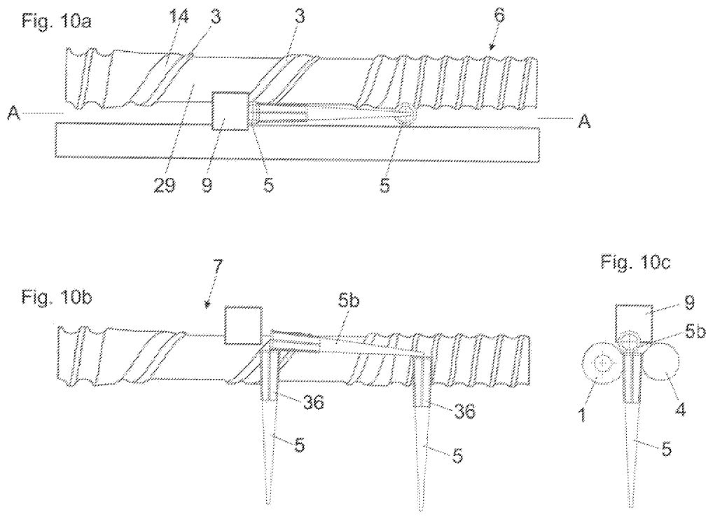

In FIGS. 10a to 10c it is represented how the control device 9 formed as a stop element, which in this case acts as a height control, can also detect pipette tips 5b that are not properly caught and remove them from the singling procedure. As can be seen with reference to the top view of FIG. 10a, in this case the pipette tip 5b that is lying on two properly caught pipette tips 5 has not been caught by the thread 2 formed as a groove 14. However, the pipette tip 5b strikes the control device 9. Since the pipette tips 5 that are properly caught are moved further in the longitudinal direction of the transport shaft 1, the pipette tip 5b can fall into the collecting area 28 at the passing area on the free spaces 29 in the acceleration area 7. FIG. 10c again shows a front view.

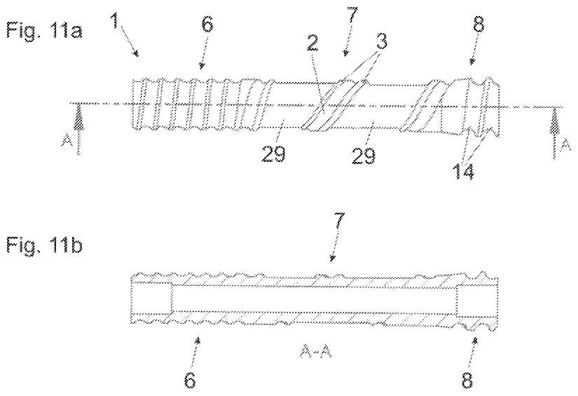

FIG. 11a shows a side view of a further embodiment of the transport shaft 1, in which the thread 2 formed as a groove 14 serves for moving the pipette tips 5 in the longitudinal direction of the transport shaft 1, as in the earlier embodiments. The thread has a first thread pitch s1 in the transfer area 6. The second thread pitch s2 in the acceleration area 7 is much greater, in order to move the pipette tips 5 more quickly in the longitudinal direction of the transport shaft 1. In the acceleration area 7, free spaces 29, which act as passing areas for pipette tips 5a, 5b that are not properly caught, are arranged in the areas between the thread 2. The dispensing area 8 is arranged after the acceleration area 7 in the axial direction. Here, the thread has a third thread pitch s3, which is smaller than the second thread pitch s2. It can be seen that the spacing d from the holding element 4 is smaller in the dispensing area 8 because the transport shaft 1 has a conically increasing diameter here. As a result, the pipette tips 5 are held more securely in the dispensing area 8 and can therefore be dispensed to the dispensing device 17 with greater precision. This can be seen well with reference to the cross-sectional representation of FIG. 11b along the section line A-A according to FIG. 11a.

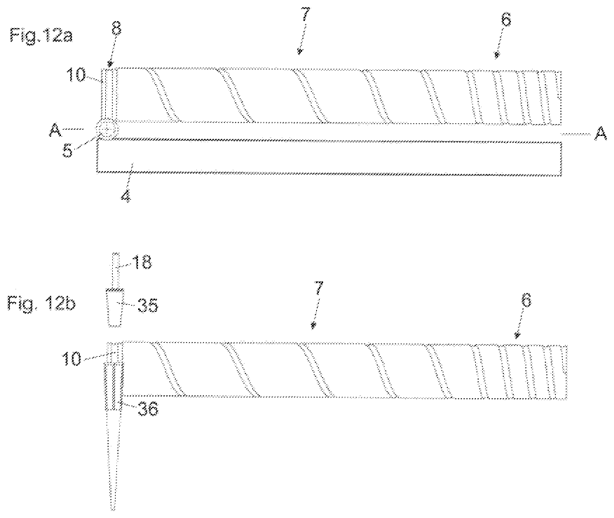

In the top view of FIG. 12a, a further embodiment of the separating apparatus 23 is shown, wherein the dispensing area 8 of the transport shaft 1 is formed as an empty run 10. The acceleration area 7 and the transfer area 6 correspond to the embodiment according to FIGS. 5a to 5c. A situation is shown in which a pipette tip 5 has been moved as far as the dispensing area 8. The dispensing area 8 has a thread 2 formed as an empty run 10, which no longer has a pitch. Thus, the pipette tip 5 can no longer move further in the longitudinal direction of the transport shaft 1 despite rotation of the transport shaft 1.

In the cross-sectional representation of FIG. 12b, it can be seen that the dispensing device 17 has a push rod 18, which can be moved up and down in a direction perpendicular to the longitudinal axis L and has a receiving element 35, which can be arranged in the collar 36 of the pipette tip 5 and is formed such that the pipette tip 5 can be held in a friction-locking manner. The push rod 18 thus serves for receiving the pipette tip 5.

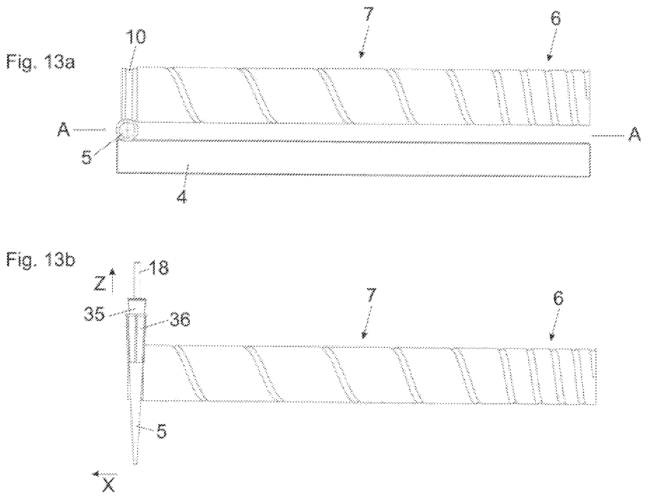

The representations of FIGS. 13a and 13b correspond to FIGS. 12a and 12b except that the push rod 18 has carried out a lowering movement downwards and therefore the receiving element 35 is arranged in the collar 36 of the pipette tip 5. In the cross-sectional representation of FIG. 13b, it can be seen that the push rod 18 together with the pipette tip 5 is moved upwards in the case of a lifting movement of the push rod 18, represented by the arrow z. The pipette tip 5 has then been dispensed by the separating apparatus 21. Subsequently, the push rod 18 together with the pipette tip 5 can be moved in the longitudinal direction, represented by the arrow x, and in a direction arranged perpendicular to the paper plane, in order to position the pipette tip 5 in a pipette tip box 25.

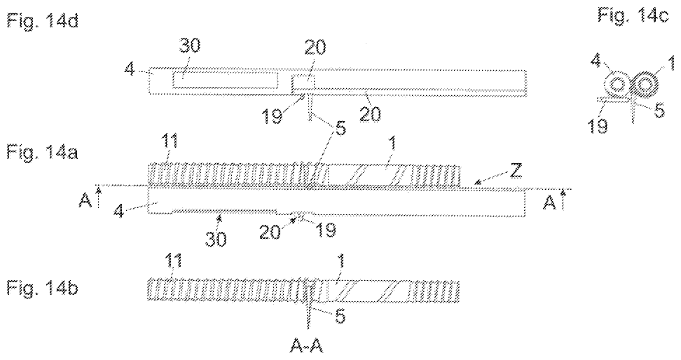

FIG. 14a shows a top view of a further embodiment of the separating apparatus 21 according to the invention. The transport shaft 1 is formed as in FIGS. 8a to 8c, but no empty run 10 is arranged at the end of the dispensing area 8. The dispensing device 17 has a dispensing shaft 11 mounted rotatable independently of the rotation of the transport shaft 1, wherein the longitudinal axis of the dispensing shaft 11 corresponds to the longitudinal axis L of the transport shaft 1. The dispensing shaft 11 has a thread 12 between the thread flanks 13, which is formed as a groove 14 and by means of which pipette tips 5 can be moved in the longitudinal direction of the dispensing shaft. For this purpose, a holding means is provided, which, together with the dispensing shaft 11, holds pipette tips in a friction-locking and also positive-locking manner, wherein a movement in the longitudinal direction of the dispensing shaft 11 is possible in the case of a rotation of the dispensing shaft 11.

In this embodiment, the holding means corresponds to the holding element 4. The holding shaft thus extends over the area of the transport shaft 1 and the dispensing shaft 11. A detection device 19, which is formed as a light barrier in this embodiment example, detects the presence of pipette tips 5 in the dispensing area 8 of the transport shaft 1 and reports this to a control device. The control device sends a signal to a stepper motor, as a result of which the dispensing shaft 11 is set in rotation. As a result, the pipette tip 5 is dispensed from the dispensing area 8 and moved further in the longitudinal direction of the dispensing shaft 11. This can also be seen with reference to the cross-sectional representation of FIG. 14b along the section line A-A according to FIG. 14a.

As can further be seen in the top view of FIG. 14a, dropping devices 20 are provided on the holding element 4 in the area which lies opposite the dispensing area 8 and the adjacent start of the dispensing shaft 11. These can be indentations, which are distributed over the circumference of the holding element 4 formed as a holding shaft. These indentations can act as passing areas, through which pipette tips 5 that are not properly caught in the grooves 14 can be dropped, in order, for example, to fall into the collecting area 28. A rotation of the holding shaft can be provided for this purpose. A further dropping device 20 is arranged in the holding shaft 4 along the entire length of the transport shaft 1. The dropping devices 20 are milled recesses. By rotating the holding shaft 4, these milled recesses 20 can be arranged such that there is no longer a connection between the pipette tips 5 and the holding element 4. As a result, the pipette tips 5 can fall into the collecting area 28. The dropping device 20 arranged along the entire length of the transport shaft 1 can be used in the case of a more serious error, with the result that the entire separating procedure starts from scratch. This can also be seen particularly well in FIG. 14d, which represents a side view of the holding element 4 formed as a holding shaft. The holding element 4 is formed along the transport shaft 1 and the dispensing shaft 11, with the result that the holding means corresponds to the holding element 4.

A transfer device 30 is further arranged on the holding shaft. In this embodiment example it is one or more millings 30 distributed over the circumference of the holding shaft which is or are arranged opposite the thread 12. The holding shaft is rotated about its longitudinal axis by an angle until the millings form a passing area for pipette tips 5 properly held in the dispensing shaft 11, which can then be positioned in the holes in the pipette tip box 25. If there are, for example, 6, 8, 12, 16 or 24 indentations in the thread 12 in the dispensing shaft 11 opposite the holding shaft, in which in each case one pipette tip 5 is held, then 6, 8, 12, 16 or 24 pipette tips can thereby be positioned in the pipette tip box 25 at the same time. FIG. 14c shows a cross-sectional representation of the separating apparatus 23 along the section line B-B represented in FIG. 14d.

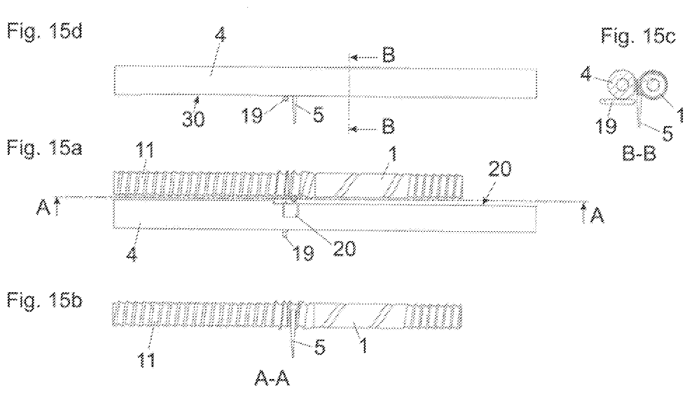

FIGS. 15a to 15d likewise show the separating apparatus 23 according to FIGS. 14a to 14d. Again, the transfer device 30 in the form of a milling can be seen in the side view of the holding element 4 according to FIG. 15d. The dropping devices 20 formed as millings can be seen in the top view of FIG. 15a. One of these millings is arranged on the holding element along the entire extent of the transport shaft 1. This milling can be brought into position by rotating the holding element 4 formed as a holding shaft, as a result of which the entire area of the transport shaft 1 and all the pipette tips 5 arranged in this area are emptied into the collecting area 28, for example into the drum 34, at the same time. It can be seen with reference to FIGS. 14a to 14d and FIGS. 15a to 15d that the transfer device 30 and the dropping devices 20, which are formed in each case as millings, are arranged on different angle ranges along the circumference of the holding element 4 formed as a holding shaft. As a result it can be ensured that only one of the dropping devices 20 is arranged opposite the transport shaft 1 or that only the transfer device 30 is arranged opposite the dispensing shaft 11.

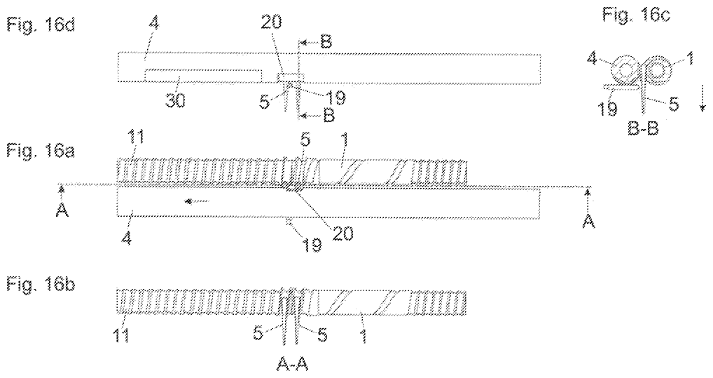

FIGS. 16a to 16d likewise show the separating apparatus 23 of FIGS. 14a to 14d and FIGS. 15a to 15d. FIGS. 16a to 16d represent how the dropping device 20, in the form of a milling arranged on the holding shaft, is brought into position in order to be able to remove pipette tips 5 arranged in the dispensing area 8 or in the adjacent area of the dispensing shaft 11 from the separating process and put them in the collecting area 28. The dropping device 20 arranged, as milling, centrally in the holding shaft in relation to the longitudinal extent, is brought into position by rotating the holding shaft. Since the milling provides more space, the connection between pipette tips 5 and holding element 4 as well as transport shaft 1 or dispensing shaft 11 is broken, since there can no longer be a positive locking or a friction locking. The pipette tips 5 which are arranged in this area fall into the collecting area 28, as is represented with reference to the arrow in FIG. 16c. This makes sense, for example, when the indentations on the dispensing shaft 11 are already fully occupied and the pipette tips 5 arranged here have not yet been able to be dispensed into a pipette tip box 25.

The normal direction of movement of the pipette tips 5 is indicated by the arrow in FIG. 16a. However, it can also prove to be necessary to return pipette tips 5 already arranged in the dispensing shaft 11. For this purpose, the direction of rotation of the dispensing shaft 11 can be altered. As a result, the pipette tips 5 are moved counter to the direction of the arrow represented. As soon as the pipette tips 5 have arrived in the area which lies opposite the dropping device 20, they can be returned to the collecting area 28 by a suitable rotation of the holding shaft, and thus subsequently into the separating apparatus 23. This makes sense e.g. when a system is restarted or when the type of pipette tips to be sorted is changed.

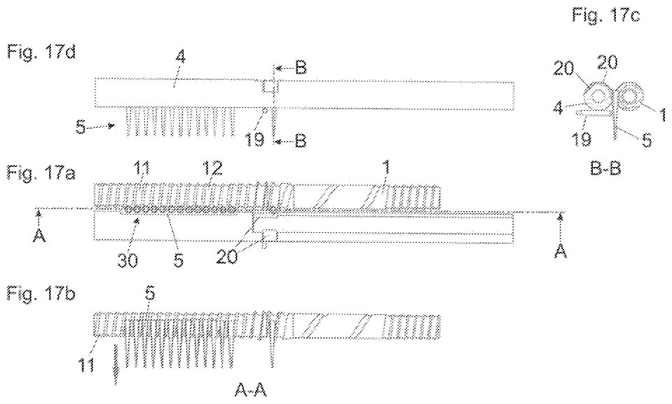

The separating apparatus 23 represented in FIGS. 17a to 17d also corresponds to the separating apparatus 23 represented in FIGS. 16a to 16d. In these figures it is now shown how the pipette tips 5 can be dispensed by the dispensing shaft 11 into a pipette tip box 25. In FIG. 17a it can be seen how, in an area of the dispensing shaft 11, in each indentation formed by the thread 12, a pipette tip 5 is arranged opposite the holding means. As soon as a pipette tip box 25 is arranged underneath the dispensing shaft 11, the holding means formed as a holding shaft can be rotated until the transfer device 30 in the form of a milling is arranged such that the connection between holding means and dispensing shaft 11 is broken. If the transfer device 30 is brought into position, there is no longer a friction locking or a positive locking. The pipette tips 5 can therefore be dispensed downwards corresponding to the direction of the arrow represented in FIG. 17b.

The dropping devices 20 formed as millings and the transfer device 30 likewise formed as a milling are represented in the cross-sectional representation of FIG. 17c along the section line B-B according to FIG. 17d. It can clearly be seen here that the pipette tip 5 can fall downwards during a corresponding rotation of the holding shaft.

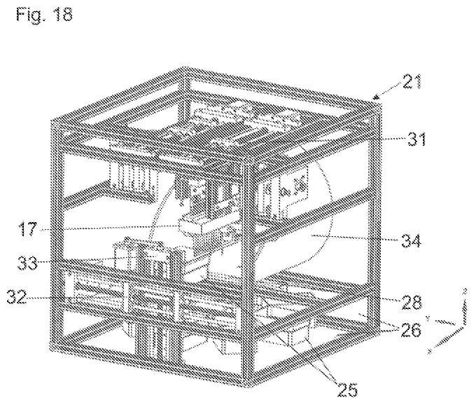

FIG. 18 shows a partially cut open perspective view of a separating and loading device 21 according to the invention. For one thing, the dispensing device 17 can be seen, wherein in this embodiment the separating apparatus 23 is mounted inside the separating and loading device 21 movable in the x direction via a guiding device 31 and in the y direction via a guiding device 32. The removal device 24 has a guiding device 33, with which pipette tip boxes 25 to be loaded can be moved in the z direction, and thus vertically in the operating state.

For positioning the pipette tips 5 in the pipette tip boxes 25, an empty pipette tip box 25 is moved vertically upwards. The separating apparatus 1 is moved in the x direction until the dispensing shaft 11 is positioned above a row of recesses in the pipette tip box 25. As soon as a number of pipette tips 5 corresponding to the number of recesses in a row of the pipette tip box 25 has accumulated in the dispensing shaft 11, the holding shaft acting as holding means is rotated about its longitudinal axis until the transfer device 30, formed as a milling, represents a passing area for the pipette tips 5 and, as a result, the pipette tips 5 could be positioned in the recesses of the pipette tip box 25. If the pipette tips 5 arranged in the dispensing shaft 11 are not sufficient to occupy all recesses in a row of the pipette tip box 25, a further forward movement of the separating apparatus 23 can be effected in the x direction. The separating apparatus is subsequently moved in the y direction in order to load the recesses of the next row of the pipette tip box 25.

If the pipette tip box 25 is fully loaded, it is moved downwards via the guiding device 33 and positioned in a storage area 26, which has a turntable. The turntable is rotated until the loaded pipette tip box 25 can be removed via an opening. A plurality of pipette tip boxes 25 can be stored in the storage area 26. The filling device 22 has a drum 34, which is arranged around the separating apparatus 21. In this embodiment example, the drum 34 is mounted non-rotatable. The inner jacket of the drum 34 acts here as a collecting area 28 for pipette tips 5a, 5b that have fallen out of the separating apparatus 21. An area of the drum 34 is provided with an inclined surface which forms the return device 27, as a result of which the removed pipette tips 5a, 5b can slide downwards due to gravity. There, these pipette tips 5a, 5b are transferred to the feed device 15.

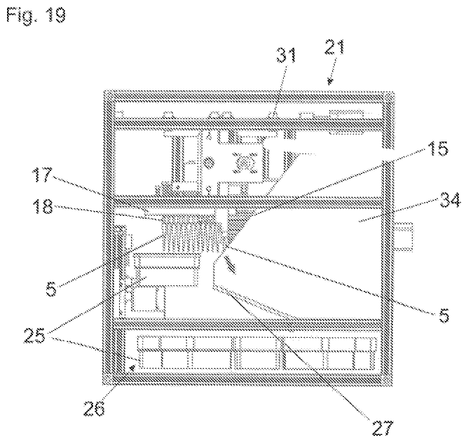

FIG. 19 shows a partially cut open side view of the separating and loading device 21 formed as a compact table-top unit. For the sake of better clarity, not all components are represented. It can be seen that the storage area represents a magazine for pipette tip boxes 25. Pipette tips 5 to be separated can be filled, for example as loose products, into the drum 34 via an opening, not shown here. There, they are transferred via a device, not shown here, to the feed device 15, from where they are fed to the separating device 16. In the situation represented here, the dispensing shaft 11 is not yet fully occupied with pipette tips 5. It can be seen that two pipette tips 5 are dropped into the collecting area 28 via the emergency dropping devices 20.

In the embodiment of the separating and loading device 21 represented in FIGS. 18 and 19, the drum 34 is mounted non-rotatable. However, an inclined surface, which acts as a collecting area 28 and as a return device 27, is arranged in the drum. Via this inclined surface, pipette tips 5 which are already outside the drum 24 in the longitudinal direction can slide back into it. The pipette tip 5 represented furthest to the right in this figure is the last pipette tip which can be picked up by the dispensing device 17. Alternatively, this pipette tip 5 can be transferred to the return device 27 via the inclined surface.

In the embodiment example represented here, the dispensing device 17 has a push rod 18 with a plurality of receiving elements 35, via which the pipette tips 5 are transferred into a pipette tip box 25. If there are too many pipette tips 5, the push rod 18 can be positioned above the drum 34 by means of the guiding devices 31 and 32. Here, the pipette tips 5 can be dispensed and returned via the return device 27.

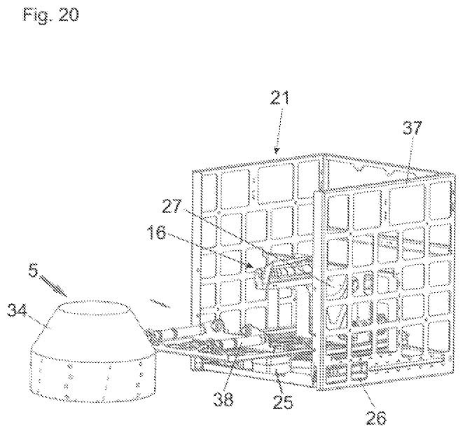

FIG. 20 shows a perspective view of parts of a further embodiment of the separating and loading device 21, wherein in this case the drum 34 is pushed into and out of the frame 37 of the separating and loading device 21 over guide rails using a drive 38. In order to pour the pipette tips 5 to be sorted into the device 21, the drum 34 is removed and the pipette tips 5 present as loose products are poured into the drum 34 via an opening. Then, the drum 34 is placed on the drive 38 and pushed into the frame 37. The separating device 16 having a transport shaft 1 and the return device 27 designed as a chute can further be seen in this figure. For reasons of clarity, the representation of further components of the separating and loading device 21 has been omitted here. The storage area 26, in which a plurality of pipette tip boxes 25 to be loaded is stored, can still be seen.

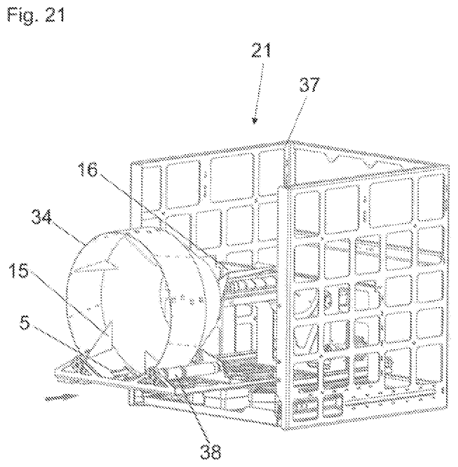

The perspective view of FIG. 21 shows how the drum 34, in which pipette tips 5 to be sorted are arranged, is introduced into the separating and loading device 21. For this, the drive 38 arranged on a movably mounted drawer is driven into the frame 37. This can be seen with reference to the arrow represented. The drive 38 has rotatably mounted drive shafts, which rotate the drum 34 using frictional contact. In this embodiment, triangular guide elements, which act as feed device 15, are arranged inside the drum 34. The pipette tips 5 are fed to the separating device 16, via these guide elements, by rotating the drum 34, because the pipette tips 5 roll down over the guide elements due to the rotation of the drum 34 and fall onto the transfer area 6 of the transport shaft 1.

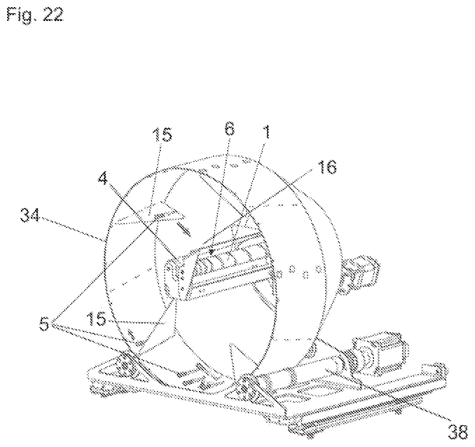

This feed procedure can be seen clearly with reference to FIG. 22. This figure shows, in a perspective view, part of the separating and loading device 21, namely the separating device 16 as well as the rotatably mounted drum 34 with the feed device 15 in the form of guide elements. As soon as pipette tips 5 come to rest on one of the guide elements they are moved upwards with the rotation of the drum 34. From a certain angle range, the pipette tips 5 then fall onto the transfer area 6 of the transport shaft 1 due to gravity. The guide elements thus form scoops or blades, which throw the pipette tips 5 onto the separating device 16 from above.

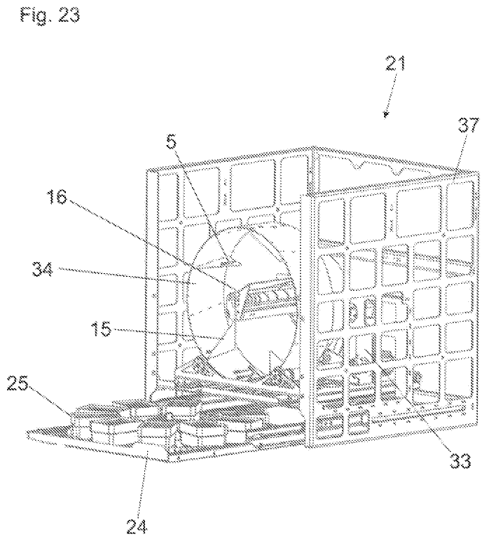

The removal device 24 can be seen in FIG. 23. In this embodiment of the separating and loading device 21, the removal device 24 has a drawer that can be moved in and out over guide rails. Arranged on this drawer is a turntable on which pipette tip boxes 25 to be loaded and those that are already loaded are stored. The guiding device 33, with which the pipette tip box 25 to be loaded can be moved vertically upwards and then the loaded pipette tip box 25 can be moved vertically downwards, can be seen in the rear area.

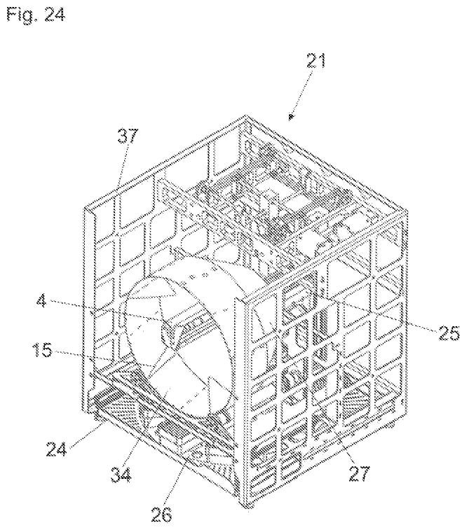

FIG. 24 shows a perspective view of this embodiment of the separating and loading device 21, wherein all essential components are now represented in this representation. The dispensing area 8 with the dispensing device 17 cannot be seen since this is located inside the drum 34.

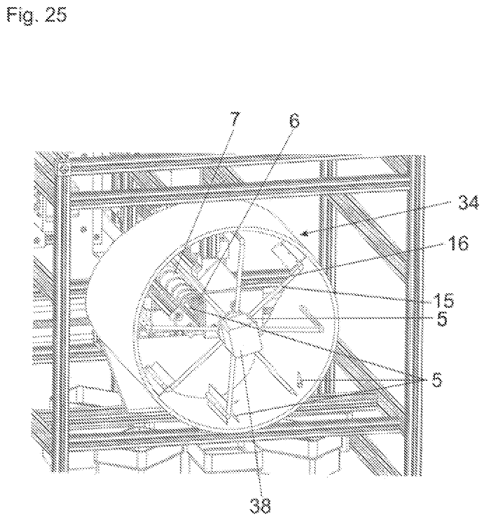

FIG. 25 shows a perspective detail view of a further embodiment of the separating and loading device 21, in which the feed device 15 is again arranged inside a rotatably mounted drum 34. In this case, the feed device 15 is formed in the shape of scoops, which are arranged along the inner circumference of the drum 34. Again, the pipette tips 5 were put in the drum 34 during the pouring in. The drum 34 is rotated by the drive 38. As a result, the pipette tips 5 are taken along by the feed device 15 formed in the shape of scoops and thrown onto the transfer area 6 of the transport shaft 1 from above.

### LIST OF REFERENCE NUMBERS

1 transport shaft
2 thread of the transport shaft
3 thread flanks of the transport shaft
4 holding element
5 pipette tip
5a pipette tips that have not been separated
5b pipette tip located outside the thread flank
6 transfer area
7 acceleration area
8 dispensing area
9 control device
10 empty run
11 dispensing shaft
12 thread of the dispensing shaft
13 thread flanks of the dispensing shaft
14 groove formed by the thread
15 feed device
16 separating device
17 dispensing device
18 push rod
19 detection device
20 dropping devices
21 separating and loading device
22 filling device
23 separating apparatus
24 removal device
25 pipette tip box
26 storage area
27 return device
28 collecting area
29 free spaces
30 transfer device
31 guiding device for movement in the x direction
32 guiding device for movement in the y direction
33 guiding device for movement in the z direction
34 drum
35 receiving element of the push rod
36 collar of the pipette tip
37 frame of the separating and loading device
38 drum drive
L longitudinal axis of the transport shaft
S center of gravity of the pipette tip
A axis of rotation for pipette tips
Z intermediate space between transport shaft and holding element
s1 first thread pitch
s2 second thread pitch
s3 third thread pitch
d, d′ spacing between transport shaft and holding element

1. Separating apparatus for pipette tips, each having a longitudinal axis, comprising:
a feed device for feeding pipette tips,
a dispensing device for dispensing pipette tips,
a separating device arranged between the feed device and the dispensing device and having a transport shaft mounted rotatable about a longitudinal axis and a holding element, arranged spaced apart from the transport shaft, for holding the pipette tips, wherein the pipette tips can be held in a friction- and positive-locking manner between the holding element and the transport shaft, and wherein the transport shaft is provided, at least in areas, with a thread, by means of which the pipette tips can be moved in an intermediate space between the transport shaft and the holding element along the longitudinal axis of the transport shaft, wherein the thread of the transport shaft is formed as a groove so that the pipette tips can be held in a positive-locking manner in the longitudinal direction of the transport shaft, and wherein the longitudinal axes of the pipette tips are arranged substantially perpendicular to the longitudinal axis of the transport shaft during the movement, and wherein the transport shaft has a transfer area for transferring the pipette tips from the feed device, wherein the thread has a first thread pitch in the transfer area, wherein the transport shaft has an acceleration area arranged after the transfer area, wherein the thread has a second thread pitch, which is greater than the first thread pitch, in the acceleration area.

2. The separating apparatus according to claim 1, wherein the holding element is formed as a preferably rotatably mounted holding shaft with a longitudinal axis arranged substantially parallel to the longitudinal axis of the transport shaft.

3. The separating apparatus according to claim 1, wherein the spacing between the transport shaft and the holding element is adjustable.

4. The separating apparatus according to claim 1, wherein a control device is provided for detecting pipette tips which have not been separated.

5. The separating apparatus according to claim 4, wherein the control device is formed as a stop element.

6. The separating apparatus according to claim 4, wherein the control device is arranged in the acceleration area.

7. The separating apparatus according to claim 6, wherein the areas between the thread in the acceleration area of the transport shaft are formed as passing areas for the pipette tips.

8. The separating apparatus according to claim 1, wherein the transport shaft has a dispensing area arranged after the acceleration area, wherein, in the dispensing area, the thread has a third thread pitch, which is smaller than the second thread pitch.

9. The separating apparatus according to claim 8, wherein an empty run is provided at the end of the dispensing area facing away from the acceleration area.

10. The separating apparatus according to claim 8, wherein the spacing between the transport shaft and the holding element is smaller in the dispensing area than in the acceleration area.

11. The separating apparatus according to claim 1, wherein the thread is formed as a groove and/or the thread flanks of the transport shaft are flattened at least in areas.

12. The separating apparatus according to claim 11, wherein the depth of the thread, in particular the depth of the groove, has different values in the dispensing area and/or in the transfer area than in the acceleration area.

13. The separating apparatus according to claim 1, wherein the dispensing device has at least one push rod, which has a receiving element mounted movable in a direction perpendicular to the longitudinal direction of the transport shaft.

14. The separating apparatus according to claim 1, wherein the dispensing device has a dispensing shaft mounted rotatable about a longitudinal axis, wherein a holding means arranged spaced apart from the dispensing shaft is provided for holding the pipette tips, and wherein the dispensing shaft is provided, at least in areas, with a thread, by means of which the pipette tips can be moved in an intermediate space between the dispensing shaft and the holding means along the longitudinal axis of the dispensing shaft.

15. The separating apparatus according to claim 14, wherein the thread on the dispensing shaft forms at least 6, 8, 12, 16 or 24 indentations on each side of the dispensing shaft.

16. The separating apparatus according to claim 14, wherein the longitudinal axis of the dispensing shaft and the longitudinal axis of the transport shaft are parallel or coincide and/or wherein the dispensing shaft and the transport shaft are mounted rotatable independently of each other.

17. The separating apparatus according to claim 14, wherein a transfer device for dispensing the pipette tips is arranged in or on the holding means.

18. The separating apparatus according to claim 1, wherein a detection device is provided for detecting a pipette tip moved into the dispensing area of the transport shaft.

19. The separating apparatus according to claim 1, wherein the holding element has at least one dropping device for moving pipette tips located outside the thread.

20. The separating and loading device for pipette tips, each having a longitudinal axis, with a filling device for pouring in pipette tips to be separated, a separating apparatus according to claim 1 and a removal device, from which pipette tips that have been separated and inserted into a pipette tip box can be removed.

21. The device according to claim 20, wherein the filling device has a rotatably mounted drum.

22. The device according to claim 20, wherein the device has a storage area for storing several pipette tip boxes.

23. The device according to claim 20, wherein a return device is provided, by means of which pipette tips not dispensed by the dispensing device can be transferred to the feed device.

24. The device according to claim 20, wherein the longitudinal axis of the transport shaft is mounted horizontally in the operating state of the device.

25. The method for operating a separating apparatus for pipette tips, each having a longitudinal axis, in particular according to claim 1, wherein the pipette tips are fed, via a feed device, to a separating device having a transport shaft mounted rotatable about a longitudinal axis, and a holding element, arranged spaced apart from the transport shaft, and wherein the pipette tips are moved, by means of a thread, which is arranged at least in areas on the transport shaft, in the intermediate space between the transport shaft and the holding element along the longitudinal axis of the transport shaft, wherein the spacing between the transport shaft and the holding element is chosen such that the pipette tips, in a transfer area of the transport shaft in which the pipette tips are transferred from the feed device, in the area of their center of gravity, are mounted rotatable about an axis arranged perpendicular to the longitudinal axis of the transport shaft.

26. The method according to claim 25, wherein the longitudinal axis of the transport shaft is mounted horizontally and, for moving the pipette tips, is rotated such that the areas of the transport shaft facing the holding element are moved upwards.
